(19) United States
(12) Patent Application Publication
(10) Pub. No.: US 2001/0026642 A1
(43) Pub. Date: Oct. 4, 2001

(54) Method and apparatus for transformation and inverse transformation of image for image compression coding

(76) Inventors: Hyun Soo Kang, Seoul (KR); Jae Won Chung, Seoul (KR); kyeong Joong Kim, Kyoungki-do (KR)

Correspondence Address: MERCHANT & GOULD PC, P.O. BOX 2903, MINNEAPOLIS, MN, 55402-0903, US

(21) Appl. No.: 09/789,237

(22) Filed: Feb. 20, 2001

(30) Foreign Application Priority Data
Feb. 21, 2000 (KR) 2000-8222

(51) Int. Cl. G06K 9/36

(52) U.S. Cl. 382/248

(57) ABSTRACT

A method and apparatus for compression transformation and inverse transformation of a digital image wherein, for the transformation and inverse transformation, a determination is made as to whether all input data values are 0, and an unnecessary transform process is skipped if all the input data values are determined to be 0, thereby reducing power consumption resulting from the unnecessary transform process. The present method and apparatus can very simply be implemented and minimize power consumption. Therefore, the present invention is significantly effective in implementing a low-power video codec essential to mobile communication terminals.

### BACKGROUND OF THE INVENTION

1. Field of the Invention

The present invention relates in general to the compression transformation and inverse transformation of a digital image, and more particularly to a method and apparatus for compression transformation and inverse transformation of a digital image wherein, for the transformation and inverse transformation, a determination is made as to whether all input data values are 0, and an unnecessary transform process is skipped if all the input data values are determined to be 0, thereby reducing power consumption.

2. Description of the Prior Art

Generally, video signal compression coding and decoding can desirably reduce the capacity of a memory necessary for storing video information as well as enable the transmission of the video information over a low-rate channel. In this regard, such compression coding and decoding techniques occupy a very important part of the multimedia industry requiring a variety of video applications such as video storage, video transmission, etc.

FIG. 1 is a block diagram schematically showing the construction of a conventional digital video compression coding system. For efficient video compression coding, there is generally used a method for estimating a motion vector by referencing a previous frame for the coding of a current frame, performing a motion compensation prediction operation using the estimated motion vector and coding the resulting prediction error. With reference to FIG. 1, the conventional video compression coding system comprises a transform unit 11 for performing a transform operation for a frame difference between an input current frame and a motion compensation prediction frame obtained by a motion compensation predictor 61, a quantizer 31 for quantizing transform coefficients from the transform unit 11 for data compression, a variable length coder 41 for performing a variable length coding (VLC) operation for the transform coefficients quantized by the quantizer 31, a dequantizer 51 and an inverse transform unit 21. In this coding system, the frame difference is reconstructed by the dequantizer 51 and inverse transform unit 21 and applied to the motion compensation predictor 61 so that it can be used to obtain a prediction frame related to the next frame. The motion compensation predictor 61 performs a motion vector estimation operation using the input current frame and a reconstructed version of a reference image and finds the prediction frame using an estimated motion vector. The motion vector estimated by the motion compensation predictor 61 is transferred to the variable length coder 41, which then variable length codes and transmits it together with the transform coefficients quantized by the quantizer 31. An image information bit stream output from the variable length coder 41 is transmitted to a receiver or a multiplexer for its multiplexing with other signals. FIG. 2 is a block diagram schematically showing the construction of a conventional digital video compression decoding system. As shown in this drawing, upon receiving a compression-coded image bit stream transmitted via a transmission medium, a variable length decoder 42 performs a variable length decoding (VLD) operation for the received image bit stream. Transform coefficients are inverse-transformed by an inverse transform unit 22 and dequantized by a dequantizer 52. Then, the original frame is reconstructed by adding a motion compensated error from a motion compensator 62 to the dequantized coefficients.

A transform coding method is a video signal compression coding method, most widely used at the present. The transform coding method is adapted to transform a video signal into coefficients—frequency coefficients—and transmit the transform coefficients centering around low-frequency components while suppressing high-frequency components. This coding method is advantageous in that a high compression ratio is ensured whereas the quality of picture is subjected to minimal deterioration. In general, two-dimensional transformation and inverse transformation of an image are performed in a row-column method with a low hardware complexity. This row-column method is adapted to obtain the results of two-dimensional transformation and inverse transformation of an image by performing one-dimensional transformation/inverse transformation respectively with respect to rows and columns of the image.

As described above, the motion compensation predictor 61 obtains a prediction frame by performing a motion vector estimation operation using a current input frame and a reference frame. In this regard, the input to the transform unit 11 is a motion compensated prediction error signal. Provided that there is a high signal similarity between consecutive frames of a moving image to be compression-coded and the motion vector estimation operation is accurately performed, a motion compensated prediction error signal input to the transform unit 11 will have such a small value as to approximate 0. On the other hand, the transform coefficients are quantized at a quantization step and then dequantized at a dequantization step. As a result, a large number of coefficients of the input to the inverse transform unit 22 in FIG. 2, more particularly a large number of AC coefficients of a high frequency band, are 0.

FIG. 3 is a block diagram showing the construction of a conventional two-dimensional transformation/inverse transformation apparatus. In this conventional apparatus, a one-dimensional discrete cosine transform/inverse discrete cosine transform (DCT/IDCT) unit 23 determines whether to perform a transformation operation or an inverse transformation operation in response to a DCT/IDCT selection signal. For the transformation operation, an input buffer 13 sequentially inputs pixel values and transfers the inputted pixel values to the one-dimensional DCT/IDCT unit 23 on an R pixels basis. The one-dimensional DCT/IDCT unit 23 performs a one-dimensional DCT operation for the pixel values from the input buffer 13 and outputs the resulting DCT coefficients to an output buffer 33. Then, the output buffer 33 stores the R results from the one-dimensional DCT/IDCT unit 23 in a transposition memory 53. After the above process is repeated up to R rows, the one-dimensional DCT operation is performed for R columns. For the one-dimensional DCT operation for the R columns, the input buffer 13 reads the one-dimensional DCT results of the R rows, stored in the transposition memory 53, in the column direction and transfers the read DCT results to the one-dimensional DCT/IDCT unit 23, which then performs the one-dimensional DCT operation for the R columns. If the one-dimensional DCT operation for the R columns is completed, then a clipping part 43 maps a value among the results of DCT, being present beyond a predetermined range, into a maximum value or minimum value. As a result, the results of two-dimensional DCT are finally obtained.

On the other hand, for the inverse transformation operation, the input buffer 13 sequentially inputs DCT coefficients and transfers the inputted DCT coefficients to the one-dimensional DCT/IDCT unit 23 on an R coefficients basis. The one-dimensional DCT/IDCT unit 23 performs a one-dimensional IDCT operation for the DCT coefficients from the input buffer 13 and outputs the resulting IDCT values to the output buffer 33. Then, the output buffer 33 stores the R results from the one-dimensional DCT/IDCT unit 23 in the transposition memory 53. After the above process is repeated up to R rows, the one-dimensional IDCT operation is performed for R columns. For the one-dimensional IDCT operation for the R columns, the input buffer 13 reads the one-dimensional IDCT results of the R rows, stored in the transposition memory 53, in the column direction and transfers the read IDCT results to the one-dimensional DCT/IDCT unit 23, which then performs the one-dimensional IDCT operation for the R columns. If the one-dimensional IDCT operation for the R columns is completed, then the clipping part 43 obtains the final pixel values of two-dimensional IDCT from the resulting pixel values from the one-dimensional DCT/IDCT unit 23.

In the above-mentioned row-column method, the input buffer 13 collects R input data and transfers the collected input data in parallel to the one-dimensional DCT/IDCT unit 23. Provided that all values of the R input data collected by the input buffer 13 are 0, all the results of one-dimensional DCT or IDCT will be 0. This fact can be confirmed from DCT and IDCT expressions as in the below equation 1 and equation 2:

$$\begin{matrix}DCT : F ( u , v ) = \frac{2}{R} C ( u ) C ( v ) {\sum }_{y = 0}^{R - 1} {\sum }_{x = 0}^{R - 1} f ( x , y ) cos \frac{( 2 x + 1 ) u π}{2 R} cos \frac{( 2 y + 1 ) u π }{2 R} & \text{[Equation 1]} \\ IDCT : f ( x , y ) = \frac{2}{R} {\sum }_{v = 0}^{R - 1} {\sum }_{u = 0}^{R - 1} C ( u ) C ( v ) f ( u , v ) cos \frac{( 2 x + 1 ) u π}{2 R} cos \frac{( 2 y + 1 ) u π }{2 R} \\ where , C ( u ) , C ( v ) = \{ \begin{matrix}\frac{1}{\sqrt{2}} , u , & v = 0 \\ 1 , & elsewhere\end{matrix} & \text{[Equation 2]}\end{matrix}$$

In the above equation 1 and equation 2, x and y are coordinate values of a spatial domain, u and v are coordinate values of a frequency domain, f(x, y) is a data value of the spatial domain, and F(u, v) is a data value of the frequency domain. Namely, the DCT result of f(x, y) is F(u, v) and the IDCT result of F(u, v) is f(x, y).

As seen from the above equations, all the results of one-dimensional DCT or IDCT are 0 if all input data values are 0. However, in spite of the fact that all the results of transformation or inverse transformation are 0 if all input data values are 0, the above-mentioned conventional transformation/inverse transformation apparatus performs the transformation and inverse transformation operations irrespective of input data values, resulting in unnecessary power consumption. This unnecessary power consumption will become a serious issue in lower-power design-based applications, for example, mobile terminals. Hence, there is a need for the improvement in such unnecessary power consumption.

### SUMMARY OF THE INVENTION

Therefore, the present invention has been made in view of the above problem, and it is an object of the present invention to provide an image compression transformation and/or inverse transformation apparatus wherein a zero detector is provided to determine whether all input data values are 0 and generate a control signal to turn off a transform/inverse transform unit upon determining that all the input data values are 0, thereby reducing power consumption.

It is another object of the present invention to provide an image compression transformation and/or inverse transformation method which is capable of analyzing the properties of input data and skipping a transformation and/or inverse transformation step as a result of the analysis, thereby significantly reducing power consumption in terms of hardware.

In accordance with one aspect of the present invention, the above and other objects can be accomplished by the provision of an apparatus for one-dimensional transformation for digital image compression, comprising a zero detector for determining whether all values of one-dimensional input data are 0 and generating a first or second control signal in accordance with the determined result; transformation means for performing a one-dimensional transformation operation for the one-dimensional input data in response to the second control signal from the zero detector; and a switch for selecting the output of the transformation means in response to the second control signal from the zero detector and the input data in response to the first control signal from the zero detector, respectively.

In accordance with another aspect of the present invention, there is provided an apparatus for one-dimensional inverse transformation for digital image compression, comprising a zero detector for determining whether all values of one-dimensional input data are 0 and generating a first or second control signal in accordance with the determined result; inverse transformation means for performing a one-dimensional inverse transformation operation for the one-dimensional input data in response to the second control signal from the zero detector; and a switch for selecting the output of the inverse transformation means in response to the second control signal from the zero detector and the input data in response to the first control signal from the zero detector, respectively.

In accordance with a further aspect of the present invention, there is provided an apparatus for one-dimensional transformation/inverse transformation for digital image compression, comprising a zero detector for determining whether all values of one-dimensional input data are 0 and generating a first or second control signal in accordance with the determined result; transformation/inverse transformation means for selectively performing a one-dimensional transformation operation or one-dimensional inverse transformation operation for the one-dimensional input data in response to the second control signal from the zero detector; and a switch for selecting the output of the transformation/inverse transformation means in response to the second control signal from the zero detector and the input data in response to the first control signal from the zero detector, respectively.

In accordance with a further aspect of the present invention, there is provided an apparatus for one-dimensional transformation/inverse transformation for digital image compression, comprising transformation/inverse transformation means for selectively performing a one-dimensional transformation operation or a one-dimensional inverse transformation operation for information of input data of a smaller unit than a bit unit of the input data; a zero detector for determining whether all values of the information of the smaller unit than the bit unit of the input data are 0 and generating a first or second control signal in accordance with the determined result to control the operation of the transformation/inverse transformation means; a switch for selecting the output of the transformation/inverse transformation means in response to the second control signal from the zero detector and the input data in response to the first control signal from the zero detector, respectively; a shift register for shifting and storing input information by the number of bits of a transformation/inverse transformation unit; and an adder for adding the output of the switch to the information stored in the shift register.

In accordance with a further aspect of the present invention, there is provided an apparatus for two-dimensional transformation/inverse transformation for digital image compression, comprising an input buffer for storing external input data with a certain bit length and output data from a transposition memory; a zero detector for determining whether all values of output data from the input buffer are 0 and generating a first or second control signal in accordance with the determined result; transformation/inverse transformation means for selectively performing a one-dimensional transformation operation or a one-dimensional inverse transformation operation for the output data from the input buffer; a switch for selecting the output of the transformation/inverse transformation means in response to the second control signal from the zero detector and the output data from the input buffer in response to the first control signal from the zero detector, respectively; an output buffer for sequentially storing output data from the switch; the transposition memory adapted for storing output data from the output buffer to transpose it on a two-dimensional plane and transferring the results of transformation/inverse transformation in one direction to the input buffer for the two-dimensional transformation/inverse transformation; and a clipping part for clipping the output data from the output buffer.

In accordance with a further aspect of the present invention, there is provided an apparatus for two-dimensional transformation/inverse transformation for digital image compression, comprising an input buffer for storing external input data with a certain bit length and output data from a transposition memory; transformation/inverse transformation means for selectively performing a one-dimensional transformation operation or a one-dimensional inverse transformation operation for information of output data from the input buffer, of a smaller unit than a bit unit of the output data from the input buffer; a zero detector for determining whether all values of the information of the smaller unit than the bit unit of the output data from the input buffer are 0 and generating a first or second control signal in accordance with the determined result to control the operation of the transformation/inverse transformation means; a switch for selecting the output of the transformation/inverse transformation means in response to the second control signal from the zero detector and the output data from the input buffer in response to the first control signal from the zero detector, respectively; an output buffer for sequentially storing output data from the switch; the transposition memory adapted for storing output data from the output buffer to transpose it on a two-dimensional plane and transferring the results of transformation/inverse transformation in one direction to the input buffer for the two-dimensional transformation/inverse transformation; and a clipping part for clipping the output data from the output buffer.

In accordance with another aspect of the present invention, there is provided a method for one-dimensional transformation for digital image compression, comprising the steps of a) determining whether all values of input data are 0; b) outputting the input data directly as the results of transformation without performing a one-dimensional transformation operation, if it is determined at the step a) that all the values of the input data are 0; and c) performing the one-dimensional transformation operation if it is determined at the step a) that all the values of the input data are not 0.

In accordance with yet another aspect of the present invention, there is provided a method for one-dimensional inverse transformation for digital image compression, comprising the steps of a) determining whether all values of input data are 0; b) outputting the input data directly as the results of inverse transformation without performing a one-dimensional inverse transformation operation, if it is determined at the step a) that all the values of the input data are 0; and c) performing the one-dimensional inverse transformation operation if it is determined at the step a) that all the values of the input data are not 0.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the construction of a conventional digital video compression coding system;

FIG. 2 is a block diagram schematically showing the construction of a conventional digital video compression decoding system;

FIG. 3 is a block diagram showing the construction of a conventional two-dimensional transformation/inverse transformation apparatus using a row-column method;

FIG. 4 is a block diagram showing the construction of a one-dimensional transformation/inverse transformation apparatus with a zero detector in accordance with the present invention;

FIG. 5 is a block diagram showing the construction of a two-dimensional transformation/inverse transformation apparatus with the zero detector in FIG. 4 in accordance with the present invention;

FIG. 6 is a view showing an embodiment of the zero detector in FIG. 4 for R=8;

FIG. 7 is a block diagram showing the construction of a conventional one-dimensional transformation/inverse transformation apparatus for R=8;

FIG. 8 is a block diagram showing the construction of a one-dimensional transformation/inverse transformation apparatus with a second zero detector for R=8 in accordance with the present invention;

FIG. 9 is a view showing an embodiment of the second zero detector in FIG. 8 for R=8; and

FIG. 10 is a flowchart illustrating a method for one-dimensional transformation and inverse transformation for image compression in accordance with the present invention.

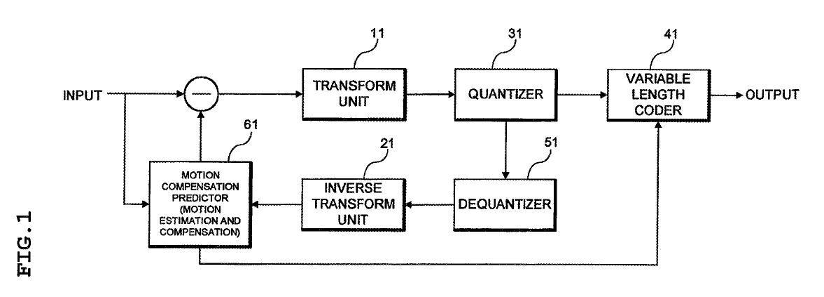

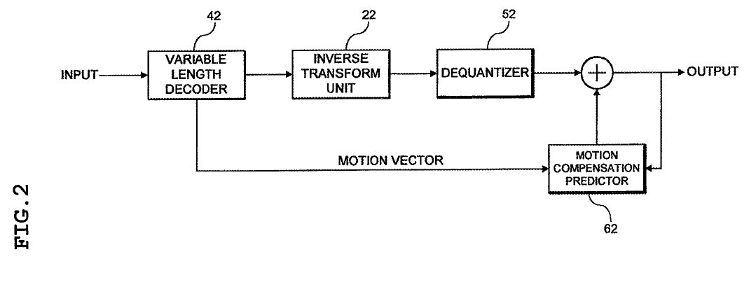

### DETAILED DESCRIPTION OF THE PREFERRED EMBODIMENTS

Before describing the present invention in detail, terms used in the specification are defined as follows.

The “image” is a term used in a broad sense in the specification, which signifies both a digital still image and digital moving image. Also, the “moving image” and “video” are terms compatible with each other in the specification.

The “transformation” signifies the transformation of information of a spatial domain into information of a frequency domain for compression of data to be transmitted. Although not necessarily limited to these, transformation methods applicable to this invention may include the following: Discrete Fourier Transform (DFT), Discrete Cosine Transform (DCT), Discrete Sine Transform (DST), Karhunen-Loeve Transform (KLT) and Walsh-Hadamard Transform (WHT). Among these transformation methods, the DCT method is particularly preferable in that the compactness of image signal energy to low-frequency components is excellent and a fast algorithm is provided.

The “inverse transformation” is the inverse of transformation, which signifies that data, transformed into that of a frequency domain, is again transformed into data of a spatial domain.

In the present invention, although the transformation and inverse transformation are not limited to particular methods, they will be described on the basis of the most general methods, or discrete cosine transform (DCT) and inverse discrete cosine transform (IDCT) methods, for the convenience of description.

In the present invention, a transformation/inverse transformation apparatus is one module which consists of a transformation unit and an inverse transformation unit to selectively perform one of a transformation operation and an inverse transformation operation in response to a selection signal from a selection terminal. This transformation/inverse transformation apparatus is adapted not to perform the transformation and inverse transformation operations at one time, but to selectively perform one of the two operations.

In a general digital image coding/decoding method or system, one frame is transformed into a group of pixels, or R pixels in the longitudinal (vertical) direction and R pixels in the transversal (horizontal) direction, which will herein be called a block with the size of R×R. Although a block with the size of 8 pixels/line×8 lines (referred to hereinafter as “8×8”) is used as the most general transform unit in existing coding/decoding methods and systems, it should herein be noted that the block size is not limited to a specific value in the present invention. On the other hand, the results of two-dimensional transformation and inverse transformation of an image are obtained by performing one-dimensional transformation/inverse transformation respectively with respect to rows and columns of the image according to a row-column method which generally has a low complexity.

In the preferred embodiment of the present invention, a digital image compression transformation apparatus and a digital image compression inverse transformation apparatus are implemented individually. For example, the digital image compression transformation apparatus of the present invention may comprise a zero detector, a transform unit and a switch. The zero detector is adapted to determine whether all values of input data are 0 and generate a control signal to control the operation of the transform unit in accordance with the determined result. Further, the zero detector applies the generated control signal to the transform unit and the switch. The transform unit is adapted to perform a transform operation for the input data in response to the control signal from the zero detector. The switch is adapted to selectively output one of the input data and output data from the transform unit in response to the control signal from the zero detector.

On the other hand, the digital image compression inverse transformation apparatus of the present invention may comprise a zero detector, an inverse transform unit and a switch. The zero detector is adapted to determine whether all values of input data are 0 and generate a control signal to control the operation of the inverse transform unit in accordance with the determined result. Further, the zero detector applies the generated control signal to the inverse transform unit and the switch. The inverse transform unit is adapted to perform an inverse transform operation for one-dimensional input data in response to the control signal from the zero detector. The switch is adapted to selectively output one of the input data and output data from the inverse transform unit in response to the control signal from the zero detector.

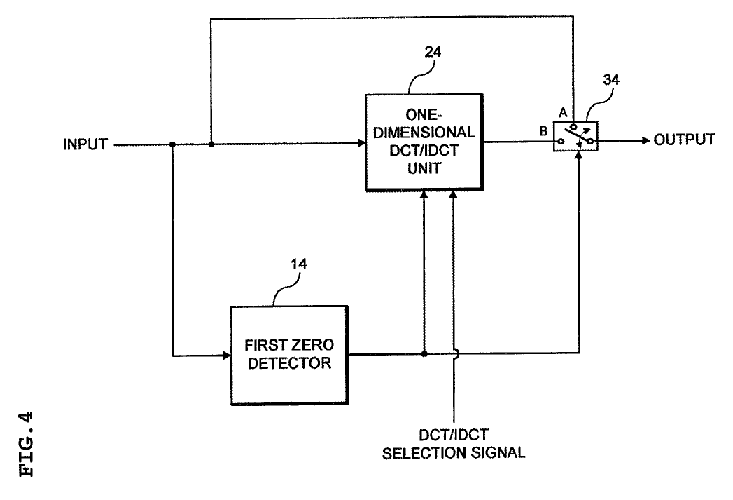

In an alternative embodiment of the present invention, a digital image compression transformation apparatus and a digital image compression inverse transformation apparatus are implemented into one module, rather than individual modules, in that they are very similar in construction. FIG. 4 is a block diagram showing the construction of a digital image compression one-dimensional transformation/inverse transformation apparatus into which the transformation apparatus and the inverse transformation apparatus are implemented in accordance with the alternative embodiment of the present invention. With reference to FIG. 4, the one-dimensional transformation/inverse transformation apparatus of the present invention comprises a first zero detector 14 for inputting DCT or IDCT data and determining whether all values of the inputted data are 0. The first zero detector 14 generates a first control signal to disable the operation of a one-dimensional DCT/IDCT unit 24 if all the values of the inputted data are 0, and a second control signal to enable the operation of the one-dimensional DCT/IDCT unit 24 if all the values of the inputted data are not 0. Further, if all the values of the inputted data are 0, the first zero detector 14 outputs the first control signal to a switch 34 to externally transfer not the results of one-dimensional DCT/IDCT from the one-dimensional DCT/IDCT unit 24 but the inputted data. In the case where all the values of the inputted data are not 0, the first zero detector 14 outputs the second control signal to the switch 34 to externally transfer not the inputted data but the results of one-dimensional DCT/IDCT from the one-dimensional DCT/IDCT unit 24. As shown in FIG. 4, the output of the first zero detector 14 is used as a control input to the switch 34 as well as a control input to the one-dimensional DCT/IDCT unit 24 for the control of its operation. That is, the switch 34 acts to select one of the output of the one-dimensional DCT/IDCT unit 24 and the data inputted by the first zero detector 14 in response to the output of the first zero detector 14.

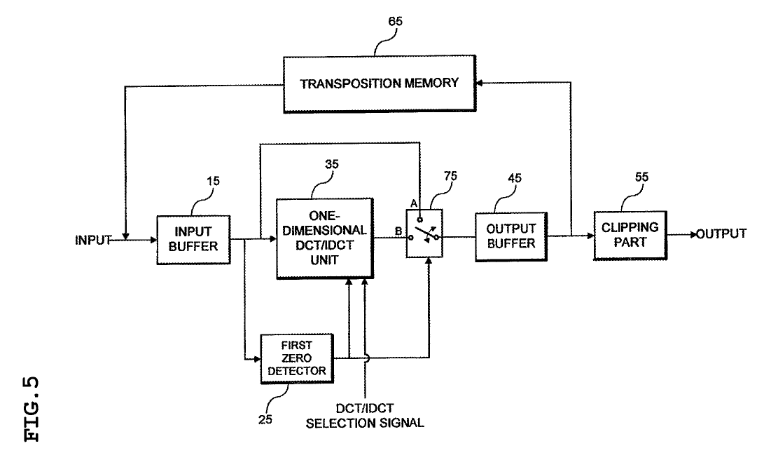

FIG. 5 is a block diagram showing the construction of a digital image compression two-dimensional transformation/inverse transformation apparatus with the first zero detector in FIG. 4 in accordance with the present invention. As shown in this drawing, the two-dimensional transformation/inverse transformation apparatus of the present invention comprises an input buffer 15 for sequentially inputting and storing data and outputting parallel data, and a first zero detector 25 for inputting output data from the input buffer 15 and determining whether all values of the inputted data are 0. A one-dimensional DCT/IDCT unit 35 functions to selectively perform a DCT operation or an IDCT operation for the output data from the input buffer 15 in response to a DCT/IDCT selection signal. A switch 75 acts to select one of the output data from the input buffer 15 and output data from the one-dimensional DCT/IDCT unit 35 in response to an output signal from the first zero detector 25. An output buffer 45 is adapted to store output data from the switch 75 in a transposition memory 65 and convert a parallel format of the output data from the switch 75 into a desired output format. The transposition memory 65 is adapted to store one-dimensional row DCT/IDCT data from the output buffer 45 to transpose it on a two-dimensional plane. A clipping part 55 acts to map a certain value of the results of DCT/IDCT from the output buffer 45 into a maximum value or a minimum value such that the DCT/IDCT results are present within a predetermined range.

In the digital image compression two-dimensional transformation/inverse transformation apparatus of FIG. 5, the first zero detector 25 determines whether all the values of the output data from the input buffer 15 are 0. If all the values of the output data from the input buffer 15 are 0, the first zero detector 25 generates a first control signal to disable the operation of the one-dimensional DCT/IDCT unit 35 and connect a movable contact of the output selection switch 75 to a fixed contact A, thereby reducing power consumption. In the case where all the values of the output data from the input buffer 15 are not 0, the first zero detector 25 generates a second control signal to enable the operation of the one-dimensional DCT/IDCT unit 35 and connect the movable contact of the output selection switch 75 to a fixed contact B, thereby allowing the one-dimensional DCT/IDCT unit 35 to perform the DCT operation or IDCT operation for the output data from the input buffer 15. In other words, the one-dimensional DCT/IDCT unit 35 is turned off in response to the first control signal from the first zero detector 25 and on in response to the second control signal from the first zero detector 25.

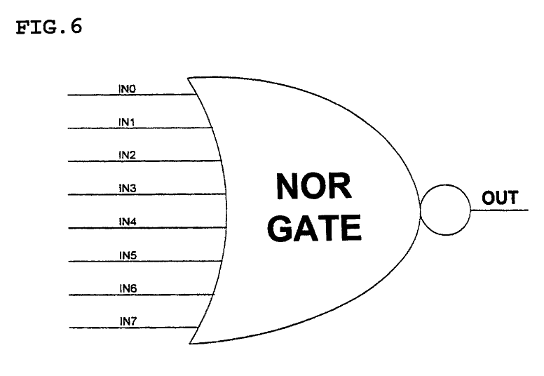

In the digital image compression two-dimensional transformation/inverse transformation apparatus of the present invention, the zero detector (14 in FIG. 4 or 25 in FIG. 5) may preferably be implemented with, for example, a NOR gate. FIG. 6 is a view showing an embodiment of the zero detector for R=8, wherein the zero detector is implemented with a NOR gate. As shown in this drawing, 8 input data IN0˜IN7 are provided as the input to the NOR gate. The output of the NOR gate is 1 if all values of the input data are 0, and 0, elsewhere. It should be noted that each of the input data IN0, IN1, . . . , IN7 is composed not of one bit, but of output bits from the input buffer. For example, in the case where a pixel value, which is input information to the DCT unit, is 8-bit information, the input data INn (n=0˜7) is composed of 8 bits. Provided that the input information to the DCT unit is a motion compensated prediction error, the input data INn (n=0˜7) will be composed of 9 bits because a negative value may be present.

A description will hereinafter be given of the usefulness of this invention for each of the two-dimensional DCT and two-dimensional IDCT. First, the usefulness of this invention for the two-dimensional DCT will be described. In a general digital image coding system, input data to a two-dimensional DCT unit is a block including a motion compensated error component having a relatively small value. In this regard, the probability that all values in the row direction will be 0 is very high for a one-dimensional DCT operation in the row direction. Therefore, the zero detector of the present invention is provided to detect such a situation where all values in the row direction are 0 and skip the unnecessary calculation, or row calculation, upon detecting such a situation, thereby reducing power consumption resulting from the row calculation. Further, if the one-dimensional DCT operation is performed in the row direction, almost all high-frequency components except low-frequency components are 0. This signifies that the probability that all values on columns corresponding to high-frequency components in the row direction will be 0 is very high for a one-dimensional DCT operation in the column direction. There is no necessity for performing the one-dimensional DCT operation in the case where all column components are 0. Accordingly, the use of the zero detector has a significant power saving effect even in the column direction.

On the other hand, for the two-dimensional IDCT, input data to a two-dimensional IDCT unit is a value obtained by quantizing a motion compensated error component and dequantizing the quantized result. Here, because the quantization step nulls all DCT components having small values, the input to the two-dimensional IDCT unit has a larger number of zero components than the input to the two-dimensional DCT unit. As a result, the probability that a one-dimensional IDCT operation will not be performed is expected to be much higher than the probability that the one-dimensional DCT operation will not be performed. Therefore, the present invention provides a greater power saving effect for the two-dimensional IDCT than the two-dimensional DCT.

Although the above advantages of the present invention have been described in connection with the case where information transformed for moving image coding is a motion compensated error, they can be effective even in an intra mode or still image where a motion compensation operation is not performed. The reason is that for the transformation, the one-dimensional transformation removes many low-frequency components and for the inverse transformation, the quantization step nulls many high-frequency components.

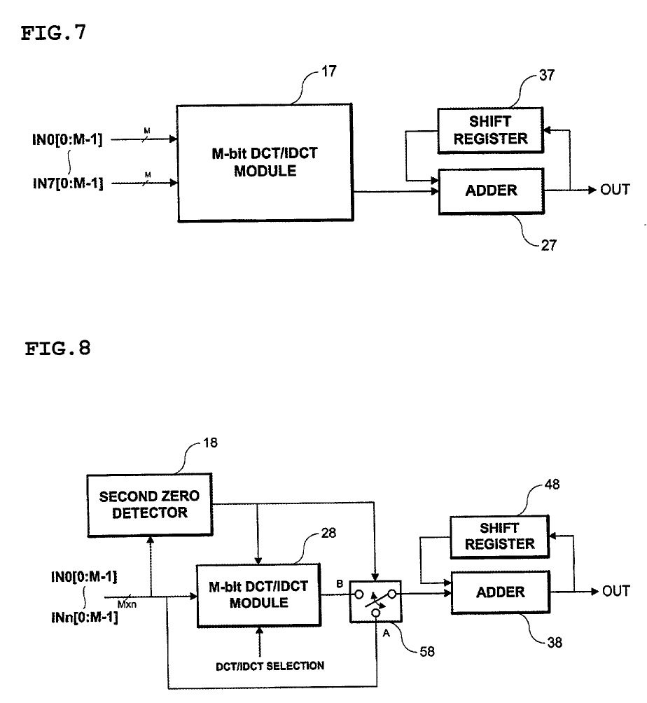

FIG. 7 shows an example of a conventional apparatus for performing a DCT or IDCT operation in a smaller unit M than a bit unit N of input data (N>M). Assuming that R input data provided by an input buffer are each composed of N bits, an M-bit DCT/IDCT module 17 processes the N bits not at one time, but P times M bits by M bits (i.e., N=M×P). A representative example of methods for performing the DCT or IDCT operation in the smaller unit M is a distributed arithmetic method. R N-bit input data will hereinafter be denoted as IN0[0:N−1], IN1[0:N−1], . . . , INR[0:N−1], where # of IN#[0:N−1] is a number of input data, and numerals in the brackets signify that the input data IN# is composed of N bits from the 0th bit up to the N−1th bit. For example, IN3[5:8] signifies that input data is composed of 4 bits from the fifth bit up to the eighth bit and numbered 3. For example, for a distributed arithmetic method where N=16 and M=2, the results of one-dimensional DCT/IDCT are obtained by performing a 2-bit DCT/IDCT operation eight times. Namely, input data to be processed are eight in number, i.e., INn[0:1], INn[2:3], INn[4:5], INn[6:7], INn[8:9], INn[10:11], INn[12:13] and INn[14:15], where n is a number of input data.

R M-bit input data (INn[0:M−1], n=0˜(R−1) and R in FIG. 7 is 8) are transformed/inverse-transformed by the M-bit DCT/IDCT module 17 and stored in a shift register 37 through an adder 27. Then, the adder 27 adds the DCT/IDCT results of the previous M-bit input data stored in the shift register 37 to the DCT/IDCT results of the subsequent M-bit input data (INn[M:2M−1], n=0˜(R−1)) and stores the added results again in the shift register 37. In this case, the DCT/IDCT results of the previous M-bit input data to be added to the DCT/IDCT results of the current M-bit input data are values shifted to the right by M bits. The results of one-dimensional DCT/IDCT are obtained by performing the above procedure P times. In the case where all values of the R M-bit input data to the M-bit DCT/IDCT module 17 are 0, all the results of DCT/IDCT are 0, as seen from the above equation 1 and equation 2. Therefore, it is preferred in terms of power saving that the M-bit DCT/IDCT module 17 is not operated when it is not necessary.

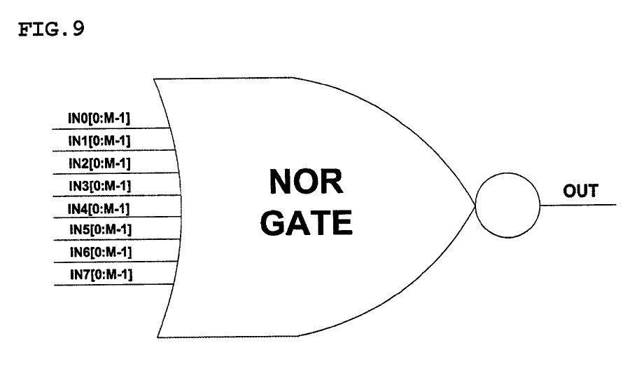

FIG. 8 is a block diagram showing the construction of a one-dimensional transformation/inverse transformation apparatus with a second zero detector for R=8 in accordance with the present invention. In this embodiment, the second zero detector is applied to a construction wherein a one-dimensional DCT/IDCT module performs DCT/IDCT operations on an M bits basis (M<N). In the one-dimensional transformation/inverse transformation apparatus of FIG. 8, an M-bit DCT/IDCT module 28 functions to selectively perform a one-dimensional DCT operation or a one-dimensional IDCT operation in response to a DCT/IDCT selection signal. In particular, the M-bit DCT/IDCT module 28 performs the DCT or IDCT operation in a smaller unit than a bit unit of input data. A second zero detector 18 determines whether all values of R M-bit input data are 0. If all the values of the R M-bit input data are 0, the second zero detector 18 generates a first control signal to disable the operation of the M-bit DCT/IDCT module 28 and connect a movable contact of a switch 58 to a fixed contact A so as to skip unnecessary calculation, thereby reducing power consumption. On the other hand, in the case where all the values of the input data are not 0, the second zero detector 18 generates a second control signal to enable the operation of the M-bit DCT/IDCT module 28 and connect the movable contact of the switch 58 to a fixed contact B, thereby allowing the M-bit DCT/IDCT module 28 to perform the DCT operation or IDCT operation for the input data. The second zero detector 18 may preferably be implemented with, for example, a NOR gate as shown in FIG. 9. The switch 58 acts to select one of the output of the M-bit DCT/IDCT module 28 and the input data in response to the output of the second zero detector 18. A shift register 48 is provided to shift and store input information by the number of bits of a DCT/IDCT unit. An adder 38 adds the output of the switch 58 to the information stored in the shift register 48. FIG. 8 shows the case where R=8 and the first M bits of N bits are processed on the assumption that the one-dimensional DCT/IDCT operations are performed in an M bits unit. The results of one-dimensional DCT/IDCT for N-bit data are obtained by performing the procedure of FIG. 8 N/M times.

As stated previously, the zero detector contributes to power saving even in the embodiment wherein the DCT or IDCT operation is performed in the smaller unit M than the bit unit N of the input data. In particular, in this embodiment, the zero detector turns off the M-bit DCT/IDCT module if values of M-bit data, not R N-bit data, are 0. The probability that all data values will be 0 for the DCT or IDCT operation in the smaller bit unit is expected to be much higher than the probability that all data values will be 0 for the DCT or IDCT operation in the bit unit N of the input data. Therefore, this embodiment will provide a greater power saving effect.

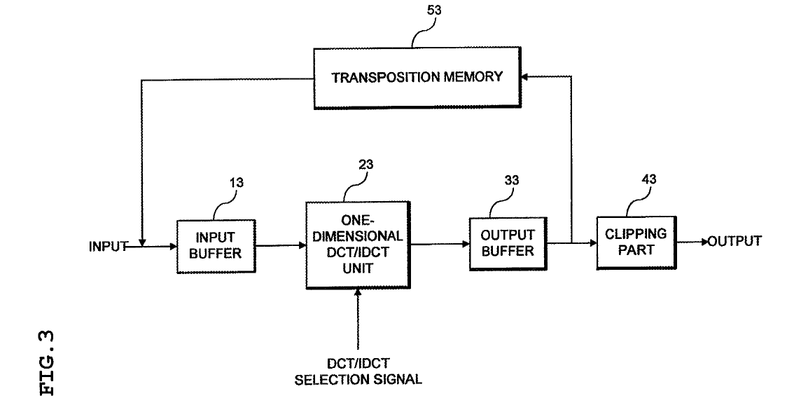

Provided that the one-dimensional DCT/IDCT module 28 in FIG. 8 is used in the one-dimensional transformation/inverse transformation apparatus of FIG. 4, it will be enabled or disabled in response to the output of the zero detector in FIG. 4. The one-dimensional transformation/inverse transformation apparatus of FIG. 4 and the one-dimensional transformation/inverse transformation apparatus of FIG. 8 can be used independently of each other. That is, only the zero detector may be used as shown in FIG. 5 and the one-dimensional DCT/IDCT module 28 in FIG. 8 may be used instead of the one-dimensional DCT/IDCT unit 23 in FIG. 3.

Although the present invention has been disclosed in connection with the DCT and IDCT, most widely used in digital image coding/decoding methods and systems, it is not limited thereto. For example, this invention is applicable to transformation such as DST or inverse transformation such as IDST.

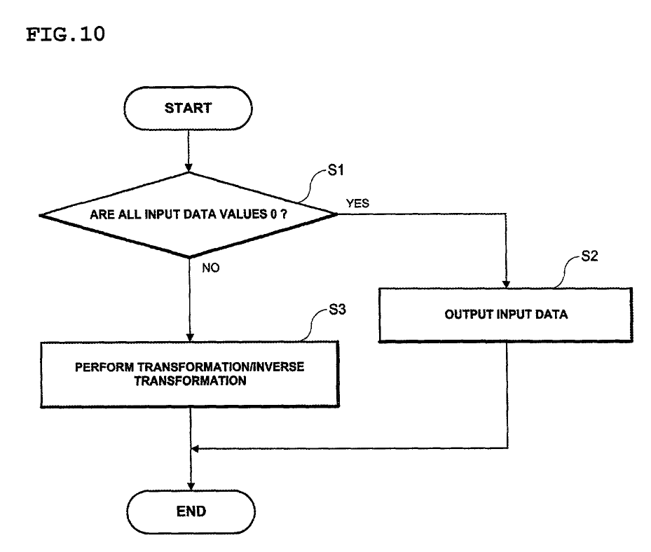

FIG. 10 is a flowchart illustrating a method for one-dimensional transformation and inverse transformation for image compression in accordance with the present invention. For the transformation for image compression, a determination is first made as to whether all values of input data are 0 (S1). If it is determined at the above step S1 that all the values of the input data are 0, a one-dimensional transformation operation is not performed and the input data are outputted directly as the results of transformation (S2). In the case where it is determined at the above step S1 that all the values of the input data are not 0, the one-dimensional transformation operation is performed and the resulting values are outputted (S3). Although not necessarily limited, a NOR operation may preferably be performed at the above step S1 to determine whether all values of input data are 0. Further, although not necessarily limited, the one-dimensional transformation operation may include Discrete Fourier Transform (DFT), Discrete Cosine Transform (DCT), Discrete Sine Transform (DST), Karhunen-Loeve Transform (KLT) or Walsh-Hadamard Transform (WHT).

For the inverse transformation for image compression, a determination is first made as to whether all values of input data are 0 (S1). If it is determined at the above step S1 that all the values of the input data are 0, a one-dimensional inverse transformation operation is not performed and the input data are outputted directly as the results of inverse transformation (S2). In the case where it is determined at the above step S1 that all the values of the input data are not 0, the one-dimensional inverse transformation operation is performed and the resulting values are outputted (S3).

Similarly to the transformation for image compression, a NOR operation may preferably be performed at the above step S1 to determine whether all values of input data are 0. Further, the one-dimensional inverse transformation operation may include Inverse Discrete Fourier Transform (IDFT), Inverse Discrete Cosine Transform (IDCT), Inverse Discrete Sine Transform (IDST), Inverse Karhunen-Loeve Transform (IKLT) or Inverse Walsh-Hadamard Transform (IWHT).

According to the present invention, the above-stated image compression one-dimensional transformation/inverse transformation method is applicable to a two-dimensional transformation/inverse transformation method. For example, for two-dimensional transformation/inverse transformation based on a row-column method, one-dimensional transformation/inverse transformation can be performed respectively with respect to rows and columns of an image. In this case, the zero detection step is performed twice, one time for each row and the other time for each column.

As apparent from the above description, the present invention provides an image compression one-dimensional transformation and/or inverse transformation method and apparatus which can analyze the properties of input data and disable a transformation and/or inverse transformation module or skip a transformation and/or inverse transformation step as a result of the analysis, thereby significantly reducing power consumption. Further, in a two-dimensional transformation/inverse transformation apparatus containing the one-dimensional transformation/inverse transformation apparatus, two zero detectors are provided to maximize the power saving effect. Therefore, the present invention is significantly effective in implementing a low-power video codec essential to mobile communication terminals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for one-dimensional transformation for digital image compression, comprising:
a zero detector for determining whether all values of one-dimensional input data are 0 and generating a first or second control signal in accordance with the determined result;
transformation means for performing a one-dimensional transformation operation for the one-dimensional input data in response to said second control signal from said zero detector; and
a switch for selecting the output of said transformation means in response to said second control signal from said zero detector and said input data in response to said first control signal from said zero detector, respectively.

2. The apparatus as set forth in claim 1, wherein said zero detector is adapted to generate said first control signal to disable the operation of said transformation means if all the values of said input data are 0 and said second control signal to enable the operation of said transformation means if all the values of said input data are not 0.

3. The apparatus as set forth in claim 1, wherein said zero detector includes a NOR gate for determining whether all the values of said input data are 0.

4. The apparatus as set forth in claim 1, wherein said transformation means is adapted to perform said one-dimensional transformation operation in any one of a discrete Fourier transform manner, discrete cosine transform manner, discrete sine transform manner, Karhunen-Loeve transform manner and Walsh-Hadamard transform manner.

5. An apparatus for one-dimensional inverse transformation for digital image compression, comprising:
a zero detector for determining whether all values of one-dimensional input data are 0 and generating a first or second control signal in accordance with the determined result;
inverse transformation means for performing a one-dimensional inverse transformation operation for the one-dimensional input data in response to said second control signal from said zero detector; and
a switch for selecting the output of said inverse transformation means in response to said second control signal from said zero detector and said input data in response to said first control signal from said zero detector, respectively.

6. The apparatus as set forth in claim 5, wherein said zero detector is adapted to generate said first control signal to disable the operation of said inverse transformation means if all the values of said input data are 0 and said second control signal to enable the operation of said inverse transformation means if all the values of said input data are not 0.

7. The apparatus as set forth in claim 5, wherein said zero detector includes a NOR gate for determining whether all the values of said input data are 0.

8. The apparatus as set forth in claim 5, wherein said inverse transformation means is adapted to perform said one-dimensional inverse transformation operation in any one of an inverse discrete Fourier transform manner, inverse discrete cosine transform manner, inverse discrete sine transform manner, inverse Karhunen-Loeve transform manner and inverse Walsh-Hadamard transform manner.

9. An apparatus for one-dimensional transformation/inverse transformation for digital image compression, comprising:
a zero detector for determining whether all values of one-dimensional input data are 0 and generating a first or second control signal in accordance with the determined result;
transformation/inverse transformation means for selectively performing a one-dimensional transformation operation or one-dimensional inverse transformation operation for the one-dimensional input data in response to said second control signal from said zero detector; and
a switch for selecting the output of said transformation/inverse transformation means in response to said second control signal from said zero detector and said input data in response to said first control signal from said zero detector, respectively.

10. The apparatus as set forth in claim 9, wherein said zero detector is adapted to generate said first control signal to disable the operation of said transformation/inverse transformation means if all the values of said input data are 0 and said second control signal to enable the operation of said transformation/inverse transformation means if all the values of said input data are not 0.

11. The apparatus as set forth in claim 9, wherein said zero detector includes a NOR gate for determining whether all the values of said input data are 0.

12. The apparatus as set forth in claim 9, wherein said transformation/inverse transformation means is adapted to perform said one-dimensional transformation operation in any one of a discrete Fourier transform manner, discrete cosine transform manner, discrete sine transform manner, Karhunen-Loeve transform manner and Walsh-Hadamard transform manner or said one-dimensional inverse transformation operation in any one of an inverse discrete Fourier transform manner, inverse discrete cosine transform manner, inverse discrete sine transform manner, inverse Karhunen-Loeve transform manner and inverse Walsh-Hadamard transform manner.

13. An apparatus for one-dimensional transformation/inverse transformation for digital image compression, comprising:
transformation/inverse transformation means for selectively performing a one-dimensional transformation operation or a one-dimensional inverse transformation operation for information of input data of a smaller unit than a bit unit of the input data;
a zero detector for determining whether all values of said information of the smaller unit than the bit unit of said input data are 0 and generating a first or second control signal in accordance with the determined result to control the operation of said transformation/inverse transformation means;
a switch for selecting the output of said transformation/inverse transformation means in response to said second control signal from said zero detector and said input data in response to said first control signal from said zero detector, respectively;
a shift register for shifting and storing input information by the number of bits of a transformation/inverse transformation unit; and
an adder for adding the output of said switch to the information stored in said shift register.

14. The apparatus as set forth in claim 13, wherein said zero detector is adapted to generate said first control signal to disable the operation of said transformation/inverse transformation means if all the values of said information of the smaller unit than said bit unit of said input data are 0 and said second control signal to enable the operation of said transformation/inverse transformation means if all the values of said information of the smaller unit than said bit unit of said input data are not 0.

15. The apparatus as set forth in claim 13, wherein said zero detector includes a NOR gate for determining whether all the values of said information of the smaller unit than said bit unit of said input data are 0.

16. The apparatus as set forth in claim 13, wherein said transformation/inverse transformation means is adapted to perform said one-dimensional transformation operation in any one of a discrete Fourier transform manner, discrete cosine transform manner, discrete sine transform manner, Karhunen-Loeve transform manner and Walsh-Hadamard transform manner or said one-dimensional inverse transformation operation in any one of an inverse discrete Fourier transform manner, inverse discrete cosine transform manner, inverse discrete sine transform manner, inverse Karhunen-Loeve transform manner and inverse Walsh-Hadamard transform manner.

17. An apparatus for two-dimensional transformation/inverse transformation for digital image compression, comprising:
an input buffer for storing external input data with a certain bit length and output data from a transposition memory;
a zero detector for determining whether all values of output data from said input buffer are 0 and generating a first or second control signal in accordance with the determined result;
transformation/inverse transformation means for selectively performing a one-dimensional transformation operation or a one-dimensional inverse transformation operation for the output data from said input buffer;
a switch for selecting the output of said transformation/inverse transformation means in response to said second control signal from said zero detector and said output data from said input buffer in response to said first control signal from said zero detector, respectively;
an output buffer for sequentially storing output data from said switch;
said transposition memory adapted for storing output data from said output buffer to transpose it on a two-dimensional plane and transferring the results of transformation/inverse transformation in one direction to said input buffer for the two-dimensional transformation/inverse transformation; and
a clipping part for clipping the output data from said output buffer.

18. The apparatus as set forth in claim 17, wherein said zero detector is adapted to generate said first control signal to disable the operation of said transformation/inverse transformation means if all the values of said output data from said input buffer are 0 and said second control signal to enable the operation of said transformation/inverse transformation means if all the values of said output data from said input buffer are not 0.

19. The apparatus as set forth in claim 17, wherein said zero detector includes a NOR gate for determining whether all the values of said output data from said input buffer are 0.

20. The apparatus as set forth in claim 17, wherein said transformation/inverse transformation means is adapted to perform said one-dimensional transformation operation in any one of a discrete Fourier transform manner, discrete cosine transform manner, discrete sine transform manner, Karhunen-Loeve transform manner and Walsh-Hadamard transform manner or said one-dimensional inverse transformation operation in any one of an inverse discrete Fourier transform manner, inverse discrete cosine transform manner, inverse discrete sine transform manner, inverse Karhunen-Loeve transform manner and inverse Walsh-Hadamard transform manner.

21. An apparatus for two-dimensional transformation/inverse transformation for digital image compression, comprising:
an input buffer for storing external input data with a certain bit length and output data from a transposition memory;
transformation/inverse transformation means for selectively performing a one-dimensional transformation operation or a one-dimensional inverse transformation operation for information of output data from said input buffer, of a smaller unit than a bit unit of the output data from said input buffer;
a zero detector for determining whether all values of said information of the smaller unit than the bit unit of said output data from said input buffer are 0 and generating a first or second control signal in accordance with the determined result to control the operation of said transformation/inverse transformation means;
a switch for selecting the output of said transformation/inverse transformation means in response to said second control signal from said zero detector and said output data from said input buffer in response to said first control signal from said zero detector, respectively;
an output buffer for sequentially storing output data from said switch;
said transposition memory adapted for storing output data from said output buffer to transpose it on a two-dimensional plane and transferring the results of transformation/inverse transformation in one direction to said input buffer for the two-dimensional transformation/inverse transformation; and
a clipping part for clipping the output data from said output buffer.

22. The apparatus as set forth in claim 21, wherein said zero detector is adapted to generate said first control signal to disable the operation of said transformation/inverse transformation means if all the values of said information of the smaller unit than said bit unit of said output data from said input buffer are 0 and said second control signal to enable the operation of said transformation/inverse transformation means if all the values of said information of the smaller unit than said bit unit of said output data from said input buffer are not 0.

23. The apparatus as set forth in claim 21, wherein said zero detector includes a NOR gate for determining whether all the values of said information of the smaller unit than said bit unit of said output data from said input buffer are 0.

24. The apparatus as set forth in claim 21, wherein said transformation/inverse transformation means is adapted to perform said one-dimensional transformation operation in any one of a discrete Fourier transform manner, discrete cosine transform manner, discrete sine transform manner, Karhunen-Loeve transform manner and Walsh-Hadamard transform manner or said one-dimensional inverse transformation operation in any one of an inverse discrete Fourier transform manner, inverse discrete cosine transform manner, inverse discrete sine transform manner, inverse Karhunen-Loeve transform manner and inverse Walsh-Hadamard transform manner.

25. A method for one-dimensional transformation for digital image compression, comprising the steps of:
a) determining whether all values of input data are 0;
b) outputting said input data directly as the results of transformation without performing a one-dimensional transformation operation, if it is determined at said step a) that all the values of said input data are 0; and
c) performing said one-dimensional transformation operation if it is determined at said step a) that all the values of said input data are not 0.

26. The method as set forth in claim 25, wherein said step a) includes the step of performing a NOR operation to determine whether all the values of said input data are 0.

27. The method as set forth in claim 25, wherein said step c) includes the step of performing said one-dimensional transformation operation in any one of a discrete Fourier transform manner, discrete cosine transform manner, discrete sine transform manner, Karhunen-Loeve transform manner and Walsh-Hadamard transform manner.

28. A method for one-dimensional inverse transformation for digital image compression, comprising the steps of:
a) determining whether all values of input data are 0;
b) outputting said input data directly as the results of inverse transformation without performing a one-dimensional inverse transformation operation, if it is determined at said step a) that all the values of said input data are 0; and
c) performing said one-dimensional inverse transformation operation if it is determined at said step a) that all the values of said input data are not 0.

29. The method as set forth in claim 28, wherein said step a) includes the step of performing a NOR operation to determine whether all the values of said input data are 0.

30. The method as set forth in claim 28, wherein said step c) includes the step of performing said one-dimensional inverse transformation operation in any one of an inverse discrete Fourier transform manner, inverse discrete cosine transform manner, inverse discrete sine transform manner, inverse Karhunen-Loeve transform manner and inverse Walsh-Hadamard transform manner.
